(19) United States
(12) Patent Application Publication
(10) Pub. No.: US 2026/0084928 A1
(43) Pub. Date: Mar. 26, 2026

(54) METHOD OF DOING MAINTENANCE ON AN ELEVATOR

(71) Applicant: Inventio AG, Hergiswil (CH)

(72) Inventors: Nicola Ischia, Milano (IT); Christian Studer, Kriens (CH); Lorenzo Panchetti, Luzern (CH); Shuhan He, Lausanne (CH); Jianhao Zheng, Ecublens (CH); Malcolm Mielle, Renens (CH)

(21) Appl. No.: 19/103,283

(22) PCT Filed: Aug. 3, 2023
(86) PCT No.: PCT/EP2023/071519

§ 371 Date: Feb. 12, 2025

(30) Foreign Application Priority Data
Aug. 19, 2022 (EP) 22191120.9

(51) Int. Cl. B66B 5/00; B66B 13/14; B66B 19/00

(52) U.S. Cl. CPC B66B 5/0093; B66B 5/0025; B66B 5/0031; B66B 13/146; B66B 19/00

(57) ABSTRACT

A method of doing regular maintenance on an elevator includes steps of: (i) putting a robot on a car of the elevator; (ii) positioning the car with the robot at a landing to admit at least one operator into the car; (iii) positioning the car with the robot and the operator at a maintenance position; (iv) executing the maintenance with the robot in response to operator input; (v) positioning the car with the robot and the operator at a landing to release the operator from the car; and (vi) taking the robot from the car.

### FIELD

The present invention relates to a method of doing maintenance on an elevator.

### BACKGROUND

An elevator has a car travelling inside an elevator shaft between landings of a building or a structure. Each landing has at least one landing door. To service the elevator, a technician may enter the elevator shaft via an access door or landing door and do maintenance on parts of the elevator arranged inside the elevator shaft. In particular, regular maintenance on the landing doors may be necessary. The technician may use a roof of the car as a work platform. The technician may move the car up and down inside the elevator shaft to reach different parts of the elevator.

However, it has been found that maintenance work inside the elevator shaft can be dangerous. Moving parts may be in reach of the technician during a movement of the car. The maintenance is also manpower intensive and routine maintenance work may alternatively be done by a robot. The robot may be situated on top or below the car and may be transported by the car from floor to floor.

EP 3 498 649 A1 describes an elevator inspection and maintenance system including a mechatronic body for performing maintenance operation.

JP 2009 184811 A describes a method of spraying an asbestos processing solvent in an elevator shaft using a robot on a car of an elevator.

Accordingly, there may be a need for an improved approach for doing maintenance on an elevator.

### SUMMARY

Such need may be met with the subject-matter of the advantageous embodiments defined in the following specification.

According to an aspect of the present invention, a method of doing regular maintenance on an elevator is proposed. The method comprises at least the following steps, preferably in the indicated order:
putting a robot on a car of the elevator, i.e. arranging the robot at the car;
positioning the car with the robot at a landing to admit at least one operator into the car, i.e. positioning the car together with the robot at a landing such that the operator may enter the car via an opened landing door;
positioning the car with the robot and the operator at a maintenance position;
executing the maintenance with the robot in response to operator input;
positioning the car with the robot and the operator at a landing to release the operator from the car, i.e. to allow the operator leaving the car via a landing door;
taking the robot from the car, i.e. removing the robot from the car.

Ideas underlying embodiments of the present invention may be interpreted as being based, inter alia, on the following observations and recognitions.

An elevator may be referred to as people mover. The elevator has at least one car travelling along rails situated inside a shaft of a building. Safety reasons require regular maintenance on the elevator. As already briefly indicated above, the maintenance may be necessary from the inside of the shaft but outside of the car. To keep humans out of the shaft, at least one robot may be put inside the shaft. Functions of the robot may be controlled by a human operator. The operator of the robot should stay in a safe place. In the presented approach, the safe place is inside an enclosed space in the car. Since the robot and the operator are in close proximity here, the robot and operator may closely cooperate and mutually complement each other.

The operator may be referred to as maintenance technician. The robot may be placed on top of the car of the elevator. It's also possible to place the robot below the car of the elevator, e.g. the robot hangs from the car's floor. The operator can safely monitor the robot's actions from inside the car. The robot may be moved from a trolley on a landing of the elevator onto the car. The robot may be self-powered or may alternatively be placed on the car by the operator. The car is a means of transport for the robot and the operator. Control equipment for controlling the robot may be placed inside the car. The control equipment may be arranged on the trolley. The interior of the car may be used as a control room for the robot. A dedicated control room in the building thus is unnecessary.

A maintenance position may be relative to the landing where the robot was previously put on the car. The maintenance position may also be relative to any other landing of the building. The maintenance position generally differs from a position of the landing, e.g. by at least a few centimeters or up to a few meters along the longitudinal direction of the elevator shaft. The maintenance position may be a position at which, upon the car reaching the maintenance position, specific functions of the elevator are initiated or are enabled. Accordingly, specific maintenance operations may be performed upon positioning the car at the maintenance position.

In the approach presented here, the robot outside the car closely cooperates with an operator inside the car. Thus, the car is brought into the maintenance position especially by the operator. The robot may at least work partially autonomously. Operator inputs, i.e. input data which is controlled and/or input by the human operator, may be transcribed into control commands for the robot. The operator inputs may define maintenance actions for the robot. The operator inputs may define whole sequences of maintenance actions. The control commands may be referred to as steering signals. The control commands for the robot may be sent wirelessly.

After the maintenance is finished, the interior of the car can be vacated, the control equipment may be taken out of the car and it can be used as people mover again. The robot may move from the car onto the trolley. The loaded trolley may then be moved to the next elevator and the maintenance procedure may be repeated.

To put the robot on the car, the car may be positioned at a mounting position with a roof of the car being accessible from the landing, a landing door at the landing may be opened and the robot may be moved from the landing onto the roof. In the mounting position, the roof may be aligned with the landing. The roof may alternatively be aligned with a load surface of the trolley.

The robot may be connected to the car after being put on the car. The robot may be mechanically connected to the car. The robot and car may have matching interfaces. The robot may be secured by positive locking. The robot may also be electrically connected to the car. The car and/or robot may have matching electrical connectors. The robot may also be connected to an outlet of the car via an extension cable. Taking the robot from the car may be done in reverse to putting the robot on the car.

The landing door may be closed after the robot is put on the car. The car may then be called to the landing to admit the operator. Admitting the operator generally means enabling that the operator may enter the car such as to get access to the interior of the car. The closed doors may ensure safety for the operator by separating the operator from the moving car. The car may be called to the landing by standard operational commands of the elevator. For example, the car may be called to the landing by using a landing operation panel (LOP). When the car is at the landing, the landing door is unlocked and opened by the opening car doors of the car. Thus, the operator is admitted and may enter the car.

At the maintenance position, the car may be positioned with an offset below a landing, to make upper components of a landing door of the landing accessible to the robot. The maintenance may then be executed on the upper components. The roof of the car may be arranged partway along the landing door. Spare parts for the maintenance and/or tools for the robot may be transported in the car. The spare parts and tools may be transported on the trolley. In the maintenance position, the landing door of the landing and the car door of the car may be opened. The robot may reach inside the car through the opened landing and car door. Through the opened doors, the operator may change tools on the robot for specific maintenance tasks. Through the doors, the operator may present necessary spare parts to the robot.

During the maintenance, the robot may set a lock mechanism of a landing door next to the car into an unlocked state. A movement command may then be given to the elevator. A safety check may be passed, if a drive system of the elevator remains inactive when the lock mechanism is in the unlocked state. A lock mechanism of a landing door normally is unlocked by the car and/or the car door when the car aligns with the landing. The landing door is then opened against a closing spring by positive locking with the car door. The lock mechanism has a switch for signaling a locked or unlocked state of the lock mechanism to a control system of the elevator. If the lock mechanism is in the unlocked state, the control system shall prevent an activation of a drive system of the elevator even if a movement command is given. The movement command may for example be given at a car panel or landing panel of the elevator. By unlocking the lock mechanism using the robot, the safety check may be executed on the switch of the unlocked landing door.

The elevator may be switched into an inspection mode for putting the robot on the car. The elevator may be switched into an operational mode for the safety check. By using a normal operation mode for the safety check, the safety check may be done under realistic circumstances. Original safety wiring of the elevator may be checked by the safety check.

The robot may open the landing door for the safety check. The robot may set the lock mechanism in the unlocked state and may open the landing door at least part way by moving the lock mechanism in an opening direction of the landing door. The unlocking and opening may be done in one continuous motion. A final position of the unlocking motion and a start position of the opening motion may be hard to target. If the landing door can be moved in the opening direction, the lock mechanism definitely is in the unlocked state.

The landing door may be locked in an opened position after the safety check. The car door may also be locked open. The robot may lock at least the landing door using a blocking tool. The operator may open the car door. The operator may alternatively manually block the landing door in the opened position from inside the car.

During the maintenance, the robot may inspect at least one predetermined part of the elevator. A state of the inspected part may be registered and may be compared to a desired state. A deviation from the desired state may be documented. The deviation may be reported to the operator. The robot may have a camera and may aim the camera at points of interest inside the shaft. Points of interest may be predefined for different kinds of elevators. Points of interest may also be defined by the operator via the operator input. A recording of the camera may be compared to a predeposited recording of the point of interest being in the desired state and/or an undesired state. The recordings may be compared using image analysis and machine learning. Differences between respective similarities of the recordings may represent deviations from the desired state. The point of interest may be tagged, and the operator may be notified of the deviations. The deviations may be highlighted in the current recording.

During the maintenance, the robot may clean at least one predetermined surface of the elevator. The predetermined surfaces may for example be situated on rails of the elevator and/or rails of a door mechanism of the landing door. The same surfaces may be cleaned from landing to landing and throughout the elevator. Alternatively or supplementary, the surfaces may be predetermined by the operator. The robot may use cleaning equipment on predetermined surfaces. The cleaning equipment may be stored inside the car. The robot may take the cleaning equipment from the interior of the car through the opened doors.

Details of the maintenance may be automatically documented for further reference. The robot may work off a maintenance protocol. Execution of steps of the maintenance may be ticked off on the protocol. By documenting the maintenance, it can be ensured that no steps are omitted and the maintenance is executed as wished.

After executing the maintenance, the car with the robot and the operator may be positioned at a different maintenance position and subsequent maintenance may be executed using the robot. The robot may have a limited reach. The car may be repositioned for other parts of the elevator to be in reach of the robot. The car may be moved step by step to cover large parts of the elevator with the robot.

The different maintenance position may be located at a different landing of the elevator. The elevator may be moved from landing to landing to do maintenance on all landings of the elevator. At each landing the steps of the maintenance may be repeated.

It shall be noted that possible features and advantages of embodiments of the invention are described herein. One skilled in the art will recognize that the features may be suitably transferred from one embodiment to another, and features may be modified, adapted, combined and/or replaced, etc. in order to come to further embodiments of the invention.

In the following, advantageous embodiments of the invention will be described with reference to the enclosed drawing. However, neither the drawing nor the description shall be interpreted as limiting the invention.

### DESCRIPTION OF THE DRAWINGS

FIG. 1 shows a sequence of steps for doing maintenance on an elevator in accordance with an embodiment of the present invention.

The FIGURE is only schematic and not to scale. Same reference signs refer to same or similar features.

### DETAILED DESCRIPTION

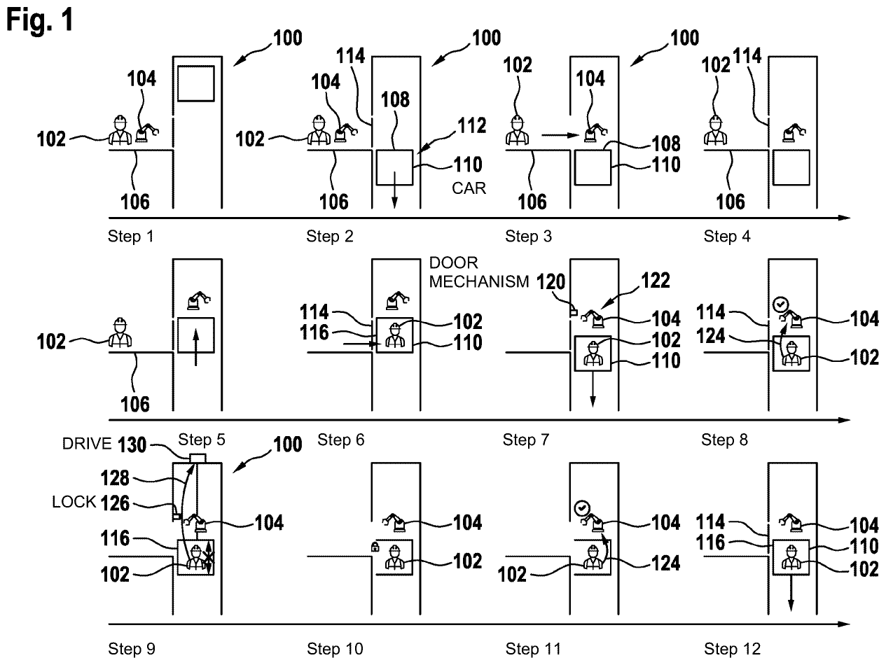

FIG. 1 shows a sequence of steps for doing maintenance on an elevator 100. The steps can be executed in the presented order. The order may also be at least partially adapted to different preconditions, such as different types of elevators 100 and/or different maintenance requirements, for example. If unnecessary, steps may also be omitted from the sequence.

In a first step, an operator 102, also referred to as technician, approaches the elevator 100 with a robot 104. The robot 104 is configured to cooperatively do maintenance on the elevator 100 in cooperation with the operator 102. The robot 104 may be transported on a trolley, a wagon, a cart or similar (not shown). The robot 104 may alternatively have wheels or tracks. The operator 102 approaches the elevator 100 on a landing 106.

In a second step, the operator 102 sets the elevator 100 in a maintenance mode and sends the elevator 100 down, so that a roof 108 of a car 110 of the elevator 100 is at a floor level of the landing 106. The car 110 is now in a mounting position 112. In the mounting position 112, the car 110 may alternatively be positioned with an offset from the floor level, to facilitate the following step of putting the robot 104 onto the roof 108 from a trolley or similar.

In the third step the operator 102 opens landing doors 114 of that landing 106 and puts the robot 104 onto the car 110. The robot 104 may be fastened to the roof 108. The robot 104 may be connected to the car 110 mechanically and, optionally, electrically.

In a fourth step, the operator 102 closes the landing doors 114 and calls the elevator 100 at the landing 106 in the following fifth step.

In a sixth step, the landing doors 114 opens with car doors 116 of the car 110 and the operator 102 enters the car 110 of the elevator 100.

In a seventh step, the operator 102 drives the elevator 100 such that the robot 104 has access to a landing door mechanism 120. The car 110 is now in a maintenance position 122.

In an eighth step, the operator 102 initiates the maintenance by providing operator input 124. The robot 104 executes the maintenance in response to the operator input 124. The operator input 124 is transformed into control commands for the robot 104. The operator input 124 may start whole sequences of maintenance actions. The operator input 124 may alternatively directly control the robot 104.

During the maintenance, the robot 104 checks if the landing doors 114 are in order. The robot 104 may have a camera to record specified areas or parts of the landing doors 114. Pictures or video from the camera may automatically be evaluated to diagnose a state of the landing doors 114. Results of the evaluation may be presented to the operator 102. Points of interest may be highlighted for the operator 102. The operator 102 may direct the camera to the points of interest. Pictures or video from the camera may be displayed to the operator for an in-depth evaluation of these points of interest.

In a ninth step, a safety check is executed during the maintenance. For the safety check, the robot 104 unlocks a lock mechanism 126 of the landing doors 114. Then the operator 102 gives a movement command 128 to a drive system 130 of the elevator 100.

The safety check is passed, if the elevator 100 does not move with the landing doors 114 unlocked.

In an embodiment, robot 104 unlocks and opens the landing doors 114 at least partially. Then the safety check is executed.

In a tenth step, the operator 102 opens the car doors 116 and locks the landing doors 114 in the open position. The robot 104 can now release the landing doors 114 and is ready for further maintenance.

In an eleventh step, the robot executes further maintenance on the landing doors 114 in response to further operator input 124. For example, the robot 104 may clean guide surfaces of the landing doors 114.

Before a twelfth step, the maintenance on this landing door 114 is finished. In the twelfth step, the operator 102 lets the landing doors 114 and the car doors 116 close and repositions the car 110 either at a new maintenance position for further maintenance at another floor, or at an exit position for exiting the car 110. Afterwards, the operator 102 can return the car 110 to the mounting position 112 to remove the robot 104 from the car 110.

In the following, possible implementations of embodiments of the approach described herein are explained once more with slightly different wording.

A collaborative routine between a collaborative robot (cobot) and a field-technician is presented e.g. for doors maintenance and safety chain control.

Conventionally, manual work from field technicians is necessary to maintain and inspect an elevator. Here, an automatized solution to improve safety and quality is proposed. The solution focuses on a collaboration scheme between a collaborative robot (cobot) and a technician. In this scheme, the technician is inside the elevator car and collaborates with a robot placed on top of the elevator car.

A technician inside the elevator car can collaborate with a cobot placed on top of the elevator car to inspect and clean doors, and to control the safety chain. In this way, the technician is safely riding inside the elevator car during a maintenance check. The technician does not need to enter the shaft.

A routine is presented to inspect and maintain the upper components of a landing door and verify the safety chain that if the landing door is unlocked, the elevator shall not move.

In an exemplary routine the technician approaches the elevator and puts it in inspection mode. Then the technician drives the elevator car such that its roof is at the floor level. The technician opens the landing doors and places a collaborative robot (cobot) on the elevator roof. The technician lets the landing doors close. Then the technician drives the elevator car to the floor and enters the car. The technician moves the elevator car such that the cobot has access to the upper components of the landing door. For maintenance, the cobot checks if the landing door is okay. The cobot unlocks and opens the landing door. For the safety check, the technician tries to make the elevator car move. The elevator should be blocked as the safety circuit is opened because of the unlocked respectively opened landing door. Then the technician opens the car door and blocks the landing door, which was kept open by the cobot up to that point. After the door is blocked, the cobot is now free to clean and operate on the opened landing door for further maintenance. After finishing the maintenance, the technician drives the elevator car to another floor and the process can repeat.

In an embodiment, the robot does the tasks autonomously. The technician simply supervises the actions of the robot. The necessary tasks can be taught to the robot. The technician can always check if the robot is acting properly. The robot can be stopped at any time.

The robot has a base that is easily attachable to the elevator car, without the need of the technician to actually enter the shaft.

The proposed approach improves safety, as there is no technician in the shaft. The approach also improves quality, as the robot can always reproduce the required maintenance and inspections tasks. The approach further improves traceability, as the robot log can be inspected to make sure that the tasks have been executed correctly.

Finally, it should be noted that the term “comprising” does not exclude other elements or steps and the “a” or “an” does not exclude a plurality. Also, elements described in association with different embodiments may be combined.

In accordance with the provisions of the patent statutes, the present invention has been described in what is considered to represent its preferred embodiment. However, it should be noted that the invention can be practiced otherwise than as specifically illustrated and described without departing from its spirit or scope.

1-13. (canceled)

14. A method of doing regular maintenance on an elevator, the method comprising steps of:
putting a robot on an outside of a car of the elevator;
positioning the car with the robot at a landing and admitting an operator into the car;
positioning the car with the robot and the operator at a maintenance position relative to the landing;
executing the maintenance with the robot in response to input from the operator;
positioning the car with the robot and the operator at the landing or at another landing and releasing the operator from the car; and
removing the robot from the car.

15. the method according to claim 14 including putting the robot on the car by positioning the car at a mounting position with a roof of the car being accessible from the landing, opening a landing door at the landing and moving the robot from the landing onto the roof.

16. The method according to claim 15 including closing the landing door after the robot is put onto the roof and the car and calling the car to the landing to admit the operator.

17. The method according to claim 14 wherein at the maintenance position including positioning the car with an offset below the landing thereby making upper components of a landing door of the landing accessible to the robot to execute the maintenance on the upper components.

18. The method according to claim 14 wherein executing the maintenance includes a safety check with the robot setting a lock mechanism of a landing door next to the car into an unlocked state, giving a movement command to the elevator, and passing the safety check when a drive system of the elevator remains inactive in response to the movement command while the lock mechanism is in the unlocked state.

19. The method according to claim 18 including switching the elevator into an inspection mode for putting the robot on the car and switching the elevator into an operational mode for executing the safety check.

20. The method according to claim 18 wherein the robot opens the landing door for executing the safety check.

21. The method according to claim 20 including locking the landing door in an opened position after the safety check is executed.

22. The method according to claim 14 wherein during the execution of the maintenance the robot inspects at least one predetermined part of the elevator, including registering a state of the inspected part and comparing the registered state to a desired state, and documenting a deviation of the registered state from the desired state.

23. The method according to claim 14 wherein during the execution of the maintenance the robot cleans at least one predetermined surface of the elevator.

24. The method according to claim 14 including automatically documenting details of the execution of the maintenance.

25. The method according to claim 14 including, after executing the maintenance, positioning the car with the robot and the operator at a different maintenance position and executing subsequent maintenance using the robot at the different maintenance position.

26. The method according to claim 25 wherein the different maintenance position is located at the another landing of the elevator spaced from the landing.
